(19) United States
(12) Patent Application Publication
(10) Pub. No.: US 2004/0212691 A1
(43) Pub. Date: Oct. 28, 2004

(54) Automatic white balance adjusting method

(76) Inventor: Genta Sato, Asaka-shi (JP)

Correspondence Address: BIRCH STEWART KOLASCH & BIRCH, PO BOX 747, FALLS CHURCH, VA, 22040-0747, US

(21) Appl. No.: 10/822,000

(22) Filed: Apr. 12, 2004

(30) Foreign Application Priority Data
Apr. 25, 2003 (JP) 2003-121724

(51) Int. Cl. H04N 9/73

(52) U.S. Cl. 348/223.1

(57) ABSTRACT

If the photographing is conducted in an automatic WB adjustment mode, the color information for each of a plurality of division areas in which one screen is divided into a plurality of areas (i.e., ratios R/G and B/G of integrated values of the RGB signals within the division area) is obtained, based on the RGB signals acquired at the time of photographing. Then, the color information for the plurality of division areas is grouped for every color information similar to each other, based on the color information for each division area, and the white balance correction values (gain values of the RGB signals) for making the while balance adjustment of the RGB signals are calculated, based on the color information included in one or more groups in which the number of color information within each group is greater than or equal to a predetermined number. Based on the white balance correction values calculated in this way, the white balance adjustment of the RGB signals acquired at the time of photographing is made.

### BACKGROUND OF THE INVENTION

1. Field of the Invention

The present invention relates to an automatic white balance adjusting method, and more particularly to an automatic white balance adjusting method for automatically adjusting the white balance properly based on the RGB signals obtained from a color image pickup element.

2. Description of the Related Art

A conventional automatic white balance adjusting method of this type is described in Japanese Patent Application Publication No. 2000-224608.

This automatic white balance adjusting method involves acquiring a brightness level of the subject and the color information for each division area in which one screen is divided into a plurality of areas (ratios R/G and B/G of the integrated values of integrating the RGB signals within division area for each color).

On the other hand, a detection frame indicating a range of color distribution corresponding to a light source species, such as a shade, blue sky, a fluorescent lamp, and a tungsten lamp, is set up on a color space of R/G and B/G, and the number of division areas in which the color information is included in each of the detection frames is obtained based on the color information for each of the acquired division areas. And the light source species is discriminated based on the detected brightness level of the subject and the number of division areas included in the detection frame, and the white balance adjustment is made based on the white balance correction values suitable for the discriminated light source species.

### SUMMARY OF THE INVENTION

However, in the invention as described in Japanese Patent Application Publication No. 2000-224608, it is required to set up the detection frame indicating a range of color distribution corresponding to a light source species on the R/G, B/G color space, in which the information of division area having no color information included in the set detection frame is not reflected to the white balance adjustment.

Also, one detection frame (light source species) is decided by the number of division areas in which the color information is included in the detection frame, whereby the color information of division area in which the color information is included in other detection frames is not reflected to the white balance adjustment. For example, when the photographing is performed under a plurality of light source species having different color temperatures, the white balance adjustment is made based on any one light source species.

This invention has been achieved in the light of the above-mentioned situation, and it is an object of the invention to provide an automatic white balance adjusting method that can automatically make the white balance adjustment by calculating the favorable white balance correction values without providing the detection frame for detecting the light source species.

According to a first aspect of the invention, there is provided an automatic white balance adjusting method, comprising a step of calculating the white balance correction values based on the RGB signals obtained from a color image pickup element, and a step of adjusting the white balance of the RGB signals based on the calculated white balance correction values, wherein the step of calculating the white balance correction values comprises a step of acquiring the color information for each of a plurality of division areas in which one screen is divided into a plurality of areas, based on the RGB signals within each division area, a step of grouping the color information for the plurality of division areas for every color information similar to each other, a step of counting the number of color information within each of the groups into which the color information is grouped and obtaining a specific group for use in calculating the white balance correction values based on the counted number, and a step of calculating the white balance correction values based on the color information contained in the specific group.

That is, the color information for each of the plurality of division areas in which one screen is divided into the plurality of areas is acquired. The step of acquiring the color information of the division area comprises a step of integrating the RGB signals within the division area for each color to obtain an integrated value for each color, and a step of acquiring the ratios R/G and B/G of the integrated value for each color and having the ratios R/G and B/G as the color information of the division area.

Then, the color information for the plurality of division areas is grouped for every color information similar to each other, based on the color information for each division area. The step of grouping comprises a step of acquiring the distance in the color information between the adjacent division areas on a color space represented by R/G and B/G, and a step of grouping the color information for the division areas as the same group when the acquired distance is less than or equal to a predetermined value.

The number of color information within each of the groups in which the color information is grouped in this way is counted and a specific group for use in calculating the white balance correction values is obtained based on the counted number.

The step of obtaining the specific group comprises obtaining the group, as the specific group, in which the number of color information within each group into the color information is grouped is greater than or equal to a predetermined number.

Also, in another form, the step of obtaining the specific group comprises obtaining, as the specific group, a group having the largest number of color information within each of the groups into which the color information is grouped.

And the white balance correction values (gain values of RGB signals) for making the white balance adjustment of the RGB signals are calculated, based on the color information included in the specific group.

The step of calculating the white balance correction values comprises calculating the white balance correction values to make the representative color information representing the color information within each group the target color information, and calculating the white balance correction values by adding the calculated white balance correction values for each group that is weighted by the number of color information with each group, when there are a plurality of the specific groups. Thereby, the representative color information for each group is employed to calculate the white balance correction values, and the white balance correction values weighted by the number of color information within the group is calculated.

In another form, the step of calculating the white balance correction value comprises calculating the white balance correction values to make the representative color information within the group having the largest number of color information the target color information.

### OPERATION OF THE INVENTION

With this invention, regarding an aggregate (group) of color information in which the number of color information similar to each other is greater than or equal to a predetermined number as one group caused by a light source species among the color information for the plurality of division areas in which one screen is divided into the plurality of areas, the white balance correction values for making the white balance adjustment are calculated based on the color information within the group. Thereby, the white balance adjustment is automatically made without the necessity of providing the detection frame for detecting the light source species. Also, when there are a plurality of groups, the white balance correction values are weighted corresponding to the number of pieces of color information within each group are calculated, whereby even when the light source species is not uniquely designated, the white balance adjustment is appropriately made.

### BRIEF DESCRIPTION OF THE DRAWINGS

FIG. 1 is a block diagram showing an electronic camera for use with an automatic white balance adjusting method according to an embodiment of this invention;

FIG. 2 is a flowchart showing a processing procedure for obtaining the white balance fine adjustment values (WB fine adjustment values) for correcting white balance adjustment errors of each camera;.

FIG. 3 is a view showing a memory table for storing the WB correction values for each light source species;

FIG. 4 is a flowchart for explaining the white balance adjusting method at the time of actual photographing; and

FIG. 5 is a graph showing a distribution of color information in a plurality of division areas on the R/G, B/G color space.

### DETAILED DESCRIPTION OF THE PREFERRED EMBODIMENTS

The preferred embodiments of an automatic white balance adjusting method according to the present invention will be described below with reference to the accompanying drawings.

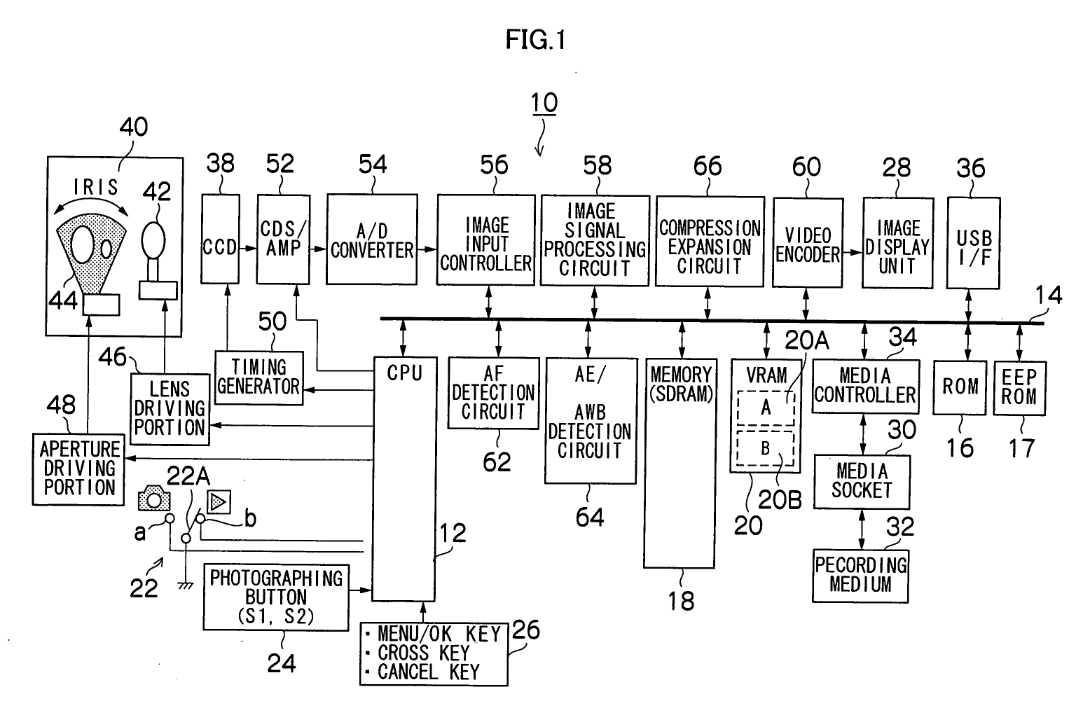

FIG. 1 is a block diagram showing an electronic camera for use with an automatic white balance adjusting method according to an embodiment of this invention.

This camera 10 is a digital camera having a recording and reproducing function of the still image and dynamic image. The overall operation of the camera 10 is comprehensively controlled by a central processing unit (CPU) 12. The CPU 12 operates as a control device for controlling this camera system in accordance with a predetermined program, as well as an arithmetic device for performing various kinds of arithmetic and logical operations, including an automatic exposure (AE) operation, an automatic focusing adjustment (AF) operation, and a white balance (WB) adjustment operation.

A ROM 16 connected via a bus 14 to the CPU 12 stores a program executed by the CPU 12 and various kinds of data necessary for the control, and an EEPROM 17 stores CCD pixel defect information and various kinds of constants/information regarding the camera operation.

Also, a memory (SDRAM) 18 is used as an expansion area of program and an operation working area of the CPU 12, and as a temporary storage area for image data or music data. A VRAM 20 is a temporary storage memory dedicated for image data, consisting of A area 20A and B area 20B. The memory 18 and VRAM 20 may be shared.

The camera 10 is provided with an operation device 26 having a mode selection switch 22, a photographing button 24, a menu/OK key, a cross key, and a cancel key. A signal sent from various kinds of operation portions (22 to 26) is input into the CPU 12, which controls each circuit of the camera 10 based on the input signal, for example, makes a lens drive control, a photographing operation control, an image processing control, an image data recording/reproducing control, and a display control for an image display unit 28.

The mode selection switch 22 is an operation device for switching between a photographing mode and a reproduction mode. When a movable armature 22A is connected to contact point a by operating the mode selection switch 20, a signal is input into the CPU 12, so that the camera 10 is set to the photographing mode. On the other hand, when the movable armature 22A is connected to contact point b, the camera 10 is set to the reproduction mode in which the recorded image is reproduced.

The photographing button 24 is an operation button for inputting an instruction to start the photographing, and a two-stage stroke switch composed of SI switch that turns on when half pressed, and S2 switch that turns on when fully pressed.

The menu/OK key is an operation key having a function of a menu button to issue a command of displaying a menu on the screen of the image display unit 28 and a function of an OK button to issue a command of confirming or executing the selected content. The cross key is an operation portion for inputting an instruction of four directions, upper, lower, left and right, and acts as a button (cursor movement operation device) for selecting an item on the menu screen or instructing the selection of various kinds of setting items from the menu. Also, an upper/lower key of the cross key acts as a zoom switch at the time of photographing or a reproduction zoom switch at the time of reproduction, and a left/right key acts as a frame feed (forward/rearward) button at the time of reproduction mode. The cancel key is usable to delete an object such as selected item as desired, cancel the instructed content, or cause the operation to return to the immediately previous operation state.

The image display unit 28 is constituted of a color liquid crystal display. The image display unit 28 is usable as an electronic finder for confirming the angle of view at the time of photographing, and employed as a reproducing/display device of the recorded image. Also, the image display unit 28 is also employed as a user interface display screen, and displays the menu information, and the information such as selection items and the set-up contents, as needed. Instead of the liquid crystal display, other display units (display devices) such as an organic EL may be employed.

The camera 10 has a media socket (media mounting portion) 30, on which a recording medium 32 is mounted. The kind of recording medium is not specifically limited, but various kinds of media may be employed such as a semiconductor memory card represented by xD-PictureCard™ and smart media™, a portable small hard disk, a magnetic disk, an optical disk, and an optical magnetic disk.

A media controller 34 makes the required signal conversion to pass an input/output signal appropriately for the recording medium 32 mounted on the media socket 30.

Also, the camera 10 comprises a USB interface portion 36 as a communication device for connection to the personal computer or other external equipment. If the camera 10 is connected to the external equipment, employing a USB cable, not shown, the camera 10 can exchange data with the external equipment. Of course, the communication method is not limited to the USB, but may be any other communication method such as the IEEE 1394 or Bluetooth.

A photographing function of the camera 10 will be described below.

If the photographing mode is selected by the mode selection switch 22, a photographing portion comprising a color CCD solid image pickup element (hereinafter referred to as CCD) 38 is supplied with electric power, so that the camera is put into a photographable state.

A lens unit 40 is an optical unit comprising a photographing lens 42 having a focus lens and a mechanical shutter with aperture 44. The lens unit 40 is electrically driven by a lens driving portion 46 and an aperture driving portion 48 controlled by the CPU 12 to make a zoom control, a focus control and an iris control.

Light passing through the lens unit 40 is made to form an image on a light receiving plane of the CCD 38. A number of photodiodes (light receiving elements) are arranged in two dimensions on the light receiving plane of the CCD 38, in which the primary color filters of red (R), green (G) and blue (B) are arranged in a predetermined array structure (e.g., Bayer, G stripe), corresponding to each photodiode. Also, the CCD 38 has an electronic shutter function for controlling the charge accumulation time (shutter speed) of each photodiode. The CPU 12 controls the charge accumulation time on the CCD 38 via a timing generator 50. Instead of the CCD 38, other image pickup elements such as a MOS type may be employed.

A subject image formed on the light receiving plane of CCD 38 is converted into signal charges corresponding to a quantity of incident light by each photodiode. The signal charges accumulated in each photodiode are sequentially read as a voltage signal (image signal) corresponding to the signal charges based on a drive pulse given from the timing generator 50 in response to a command of the CPU 12.

A signal output from the CCD 38 is sent to an analog processing portion (CDS/AMP) 52, where the RGB signals for each pixel are sampled and held (correlation dual sampling process), amplified, and added to an A/D converter 54. The RGB signals in dot sequence are converted into digital signals by the A/D converter 54, and stored via an image input controller 56 in the memory 18.

An image signal processing circuit 58 processes the RGB signals stored in the memory 18 in response to a command of the CPU 12. That is, the image signal processing circuit 58 acts as an image processing device comprising a coincidence circuit (a processing circuit for making the coincident conversion of color signal by interpolating a spatial chromatic aberration of color signal associated with a color filter array of single plate CCD), a white balance correction circuit, a gamma correction circuit, a contour correction circuit, and a brightness/color difference signal generating circuit, and performs a predetermined signal processing, while making effective use of the memory 18, in response to a command from the CPU 12.

The RGB image data input into the image signal processing circuit 58 is converted into a brightness signal (Y signal) and the color difference signals (Cr, Cb signals) in the image signal processing circuit 58, which are subjected to the predetermined processing such as gamma correction. The image data processed in the image signal processing circuit 58 is stored in the VRAM 20.

When the photographed image is monitored on the image display unit 28, the image data is output from the VRAM 20, and sent via the bus 14 to a video encoder 60. The video encoder 60 converts the input image data into a predetermined display signal (e.g., NTSC color composite video signal), which is then output to the image display unit 28.

The image data representing one frame of image is rewritten in A area 20A and B area 20B alternately by the image signal output from the CCD 38. Of A area 20A and B area 22B of the VRAM 22, the written image data is read from the area other than the area in which the image data is rewritten. In this manner, the image data within the VRAM 20 is periodically rewritten. A video signal generated from the image data is supplied to the image display unit 28, whereby the video being picked up is displayed in real time on the image display unit 28. A photographer confirms the angle of view of photographing with the video (through movie picture) displayed on the image display unit 28.

If the photographing button 24 is half pressed to turn S1 on, the camera 10 starts the AE and AF processing. That is, an image signal output from the CCD 38 is A/D converted, and input via the image input controller 56 into an AF detection circuit 62 and an AE/AWB detection circuit 64.

The AE/AWB detection circuit 64 comprises a circuit for dividing one screen into a plurality of areas (e.g., 16×16) and integrating up the RGB signals for each division area, an integrated value being provided to the CPU 12. The CPU 12 detects a luminosity of the subject (subject brightness) based on the integrated value obtained from the AE/AWB detection circuit 64 and calculates an exposure value (photographing EV value) appropriate for photographing. An aperture value and a shutter speed are decided in accordance with the calculated exposure value and a predetermined program, whereby the CPU 12 controls the electronic shutter and the iris of the CCD 28 to attain the proper exposure.

Also, the AE/AWB detection circuit 64 calculates the average integrated value for each color of RGB signals in every division area, and provides the calculated results to the CPU 1, when the automatic white balance adjustment is made. The CPU 12 acquires the integrated values of R, G and B, calculates the ratios R/G and B/G in every division area, discriminates a light source species, based on a distribution of R/G and B/G values on the R/G, B/G color space, and controls the gain values (white balance correction values) of RGB signals in accordance with the white balance adjustment values appropriate for the discriminated light source species in the white balance adjusting circuit, so that the value of each ratio may be about 1 (i.e., the integrating ratio of RGB on one screen is R:G:B=1:1:1), thereby correcting the signal on each color channel. If the gain values of the white balance adjusting circuit are adjusted so that the value of each ratio described above may be other than 1, the image with some color unevenness is generated. The details of the white balance adjustment will be described later.

For the AF control in the camera 10, the contrast AF is applied in which a focusing lens (a movable lens contributing to the focus adjustment of the lens optical system constituting the photographing lens 42) is moved so that the high frequency components of G signal in the video signal may be maximized. That is, the AF detection circuit 62 is composed of a high pass filter for passing only the high frequency components of the G signal, an absolute value processing portion, an AF area extracting portion for extracting the signal within a focus object area that is preset on the screen (e.g., a central part of screen), and an integrating portion for integrating the absolute value data within the AF area.

The data of integrated values obtained in the AF detection circuit 62 is notified to the CPU 12. The CPU 12 controls the lens driving portion 46 to move the focusing lens, while calculating the focus evaluation value (AF evaluation value) at each of a plurality of AF detection points, and decides the lens position having the maximal evaluation value as the focusing position. And the lens driving portion 46 is controlled so that the focusing lens may be moved to the decided focusing position. The AF evaluation value may be calculated employing the brightness signal (Y signal), instead of the G signal.

If the photographing button 24 is half pressed to turn S1 on, the AE/AF processing is performed. If the photographing button 24 is fully pressed to turn S2 on, the photographing operation for recording is started. The image data acquired in response to turning S2 on is converted into the brightness/color difference signal (Y/C signal) in the image signal processing circuit 58, which is then subjected to the predetermined image processing such as gamma correction, and stored in the memory 18.

The Y/C signal stored in the memory 18 is compressed in a predetermined format by a compression expansion circuit 66, and recorded via the media controller 34 in the recording medium 32. For example, the still image is recorded in a JPEG (Joint Photographic Experts Group) format.

If the reproduction mode is selected by the mode selection switch 22, the compressed data of the final image file (finally recorded file) recorded in the recording medium 32 is read. When the finally recorded file is a still image file, the read image compressed data is expanded to an uncompressed YC signal by the compression expansion circuit 66, converted into a display signal by the image signal processing circuit 58 and the video encoder 60, and output to the image display unit 28. Thereby, the image contents of the file are displayed on the screen of the image display unit 28.

If the right key or left key of the cross key is operated during reproduction of one frame of still image (including reproduction of the initial frame of dynamic image), a reproduction object file can be switched (forward frame feed/reverse frame feed). The image file at the frame fed position is read from the recording medium 32, and the still image or dynamic image is reproduced and displayed on the image display unit 28 in the same manner as above.

A method for adjusting a dispersion in the equipment will be described below.

The camera 10 or the lens, even of the same type, has a dispersion in the CCD spectral sensitivity. Hence, when the white balance adjustment is performed employing the white balance correction values (WB correction values) prepared in advance according to the light source species, each camera has a white balance adjustment error (chromatic aberration). Thus, the white balance adjustment error for each camera is compensated to allow the white balance adjustment, like the white balance adjustment of the standard camera.

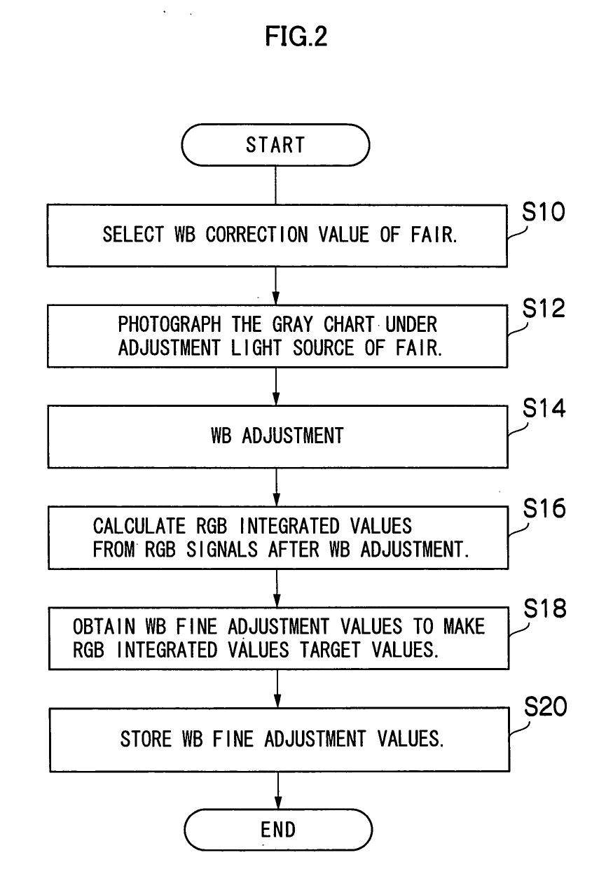

FIG. 2 is a flowchart showing a processing procedure for obtaining the white balance fine adjustment values (WB fine adjustment values) for compensating the white balance adjustment error for each camera. This processing is performed at the time of adjustment before shipment of the camera.

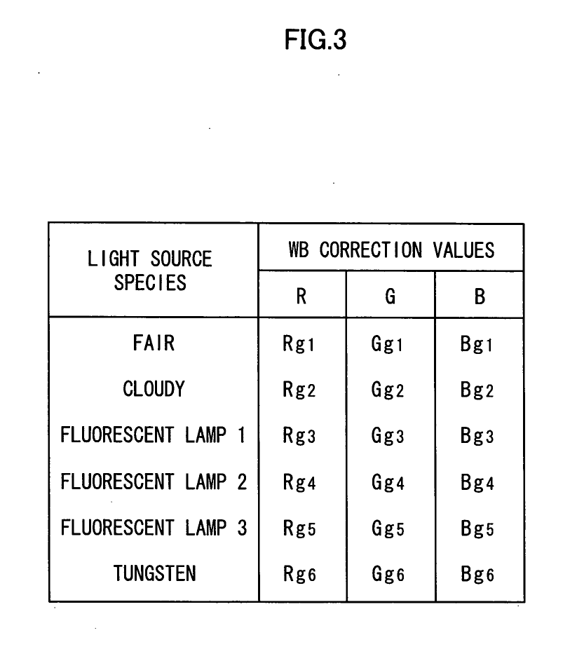

In FIG. 2, first of all, the menu screen is displayed on the image display unit 28 of the camera 10, and a predetermined light source species (fair “day light” in this embodiment) for making the white balance manually is selected on the menu screen (step S10). This selection is made by operating the cross key and the menu/OK key. Also, the selected WB correction values are read from the memory table of WB correction values (RGB gain values) preset for each light source species by selecting this light source species, as shown in FIG. 3.

The memory table as shown in FIG. 3 has the entries of light source species, including fair, shade-cloudy, fluorescent lamp 1 (daylight fluorescent lamp), fluorescent lamp 2 (day white color fluorescent lamp), fluorescent lamp 3 (white color fluorescent lamp), and tungsten lamp, and stores the WB correction values of RGB for each light source color, to make the white balance adjustment of image appropriately at the time of photographing under the light source species. Also, the WB correction values are set for each light source species, presupposing that the spectral sensitivity of lens or CCD accords with the design specifications of the standard camera.

Then, the gray chart (N5 gray) is photographed under the fair adjusted light source (step S12), and the white balance adjustment is made by multiplying the RGB signals obtained from the CCD 38 at the time of photographing by the preset WB correction values (R_{g1}, G_{g1}, B_{g1}) of fair (step S14).

Subsequently, the average integrated values (Rₘₑₐₙ, Gₘₑₐₙ, Bₘₑₐₙ) for RGB over the full one screen are calculated from the RGB signals after the white balance adjustment (step S16). Based on the calculated average integrated values of RGB and the target average integrated values (target values R_{ref}, G_{ref}, B_{ref}, for example, RGB ratio=121:121:116 for N5 gray target values in the fair weather) for RGB obtained by photographing under the fair light source species, the WB fine adjustment values (ΔR_{g}, ΔG_{g}, ΔB_{g}) for compensating the white balance adjustment errors are calculated by the following expressions (step S18).

ΔR_{g}=R_{ref}l /Rₘₑₐₙ

ΔG_{g}=G_{ref}/Gₘₑₐₙ

ΔB_{g}=B_{ref}/Bₘₑₐₙ [Formula 1]

The WB fine adjustment values (ΔR_{g}, ΔG_{g}, ΔB_{g}) obtained in this way are stored in the EEPROM 17 (step S20).

The RGB signals obtained from the CCD 38 at the time of photographing by the camera 10 are multiplied by the WB fine adjustment values (ΔR_{g}, ΔG_{g}, ΔB_{g}) stored in the EEPROM 17. Thereby, even when there is a dispersion in the spectral sensitivity characteristic of the lens unit 40 or the CCD 38 for each camera, the RGB signals modified for chromatic aberration due to the dispersion are obtained.

Also, the target values R_{ref}, G_{ref}, B_{ref} for use to calculate the WB fine adjustment values (ΔR_{g}, ΔG_{g}, ΔB_{g}) are stored in advance in the memory within the camera. Moreover, the WB fine adjustment values are obtained based on not only photographing under the fair adjustment light source, but also photographing under other color temperature adjustment light sources, or the optimal WB fine adjustment values may be obtained from plural WB fine adjustment values obtained under plural adjustment light sources.

Moreover, the above WB fine adjustment values may be calculated and recorded in the EEPROM 17 not only in the camera 10 itself, but also the external adjustment equipment useful at the time of the white balance adjustment.

The white balance adjustment at the time of actual photographing using the above WB fine adjustment values will be described below.

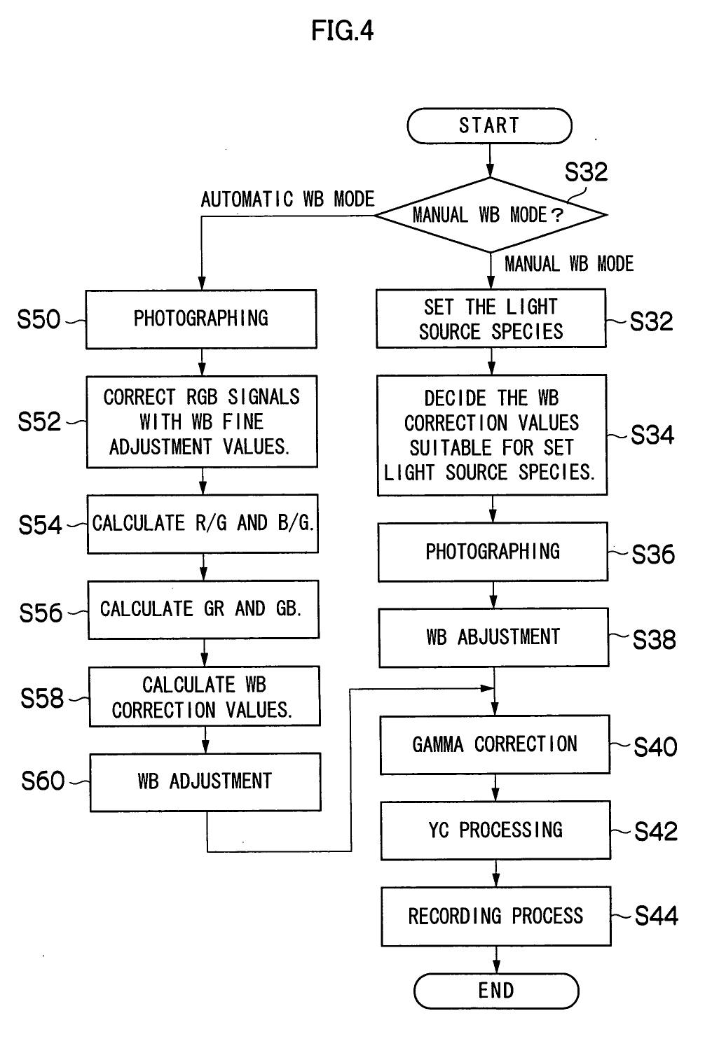

In FIG. 4, first of all, it is discriminated whether the WB adjustment mode set in the camera 10 is the manual WB adjustment mode or the automatic WB adjustment mode (step S30). To discriminate between the manual WB adjustment mode and the automatic WB adjustment mode, when the specific light source species is selected by operating the cross key and the menu/OK key in the manual photographing mode, the WB adjustment mode is discriminated as the manual WB adjustment mode, or when the “AUTO” menu is selected, the WB adjustment mode is discriminated as the automatic WB adjustment mode. Also, when the photographing mode is the automatic photographing mode, the WB adjustment mode automatically becomes the automatic WB adjustment mode.

If the WB adjustment mode is discriminated as the manual WB adjustment mode, the light source species selected by the user is set as the light source species for illuminating the photographing subject (step S32), and the WB correction values suitable for photographing under the set light source species are decided (step S34), as shown in FIG. 3.

Thereafter, if the photographing button 24 is pressed, the photographing is made in the manual photographing mode (step S36), in which the RGB signals obtained from the CCD 38 at the time of photographing are once stored in the memory 18, and then the white balance adjustment for the RGB signals is performed (step S38). This white balance adjustment for the RGB signals is made based on the WB correction values decided at step S34, and the WB fine adjustment values as described in the flowchart of FIG. 2. That is, the color signals of the RGB signals are multiplied by the WB fine adjustment values (ΔR_{g}, ΔG_{g}, ΔB_{g}), and multiplied by the WB correction values according to the light source species.

Thereafter, the image processings, such as gamma processing and YC processing are performed for the RGB signals, for which the white balance adjustment is made, and the Y/C signals that are YC processed are compressed in a predetermined format and recorded in the recording medium 32 (steps S40 to S44).

An automatic white balance adjustment method according to this invention will be described below.

If the automatic WB adjustment mode is discriminated at step S32 in FIG. 4, the automatic white balance adjustment according to the invention is performed. That is, if the photographing button 24 is pressed in the automatic WB adjustment mode, the subject is photographed (step S50).

The RGB signals obtained from the CCD 38 at the time of photographing are once stored in the memory 18, and multiplied by the WB fine adjustment values (ΔR_{g}, ΔG_{g}, ΔB_{g}) by the RGB signals to correct in advance the adjustment errors due to dispersion of sensitivity in the lens and CCD characteristics for each camera (step S52). The corrected RGB signals are stored in the memory 18 again.

Employing the RGB signals after correction that are stored in the memory 18, the average integrated value for each color of the RGB signals is calculated for each of 256 division areas in which one screen is divided into 16×16, and the ratios of average integrated values of RGB (i.e., R/G and B/G ratios) are calculated for each division area (step S54).

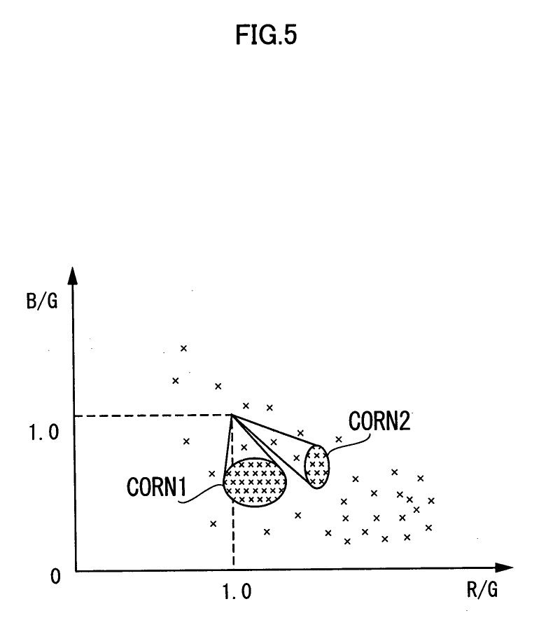

The pieces of color information for each of 256 division areas calculated in the above way are represented as 256 points distributed on the R/G, B/G color space, based on the R/G and B/G values, as shown in FIG. 5.

Subsequently, the distance D between the pieces of color information (R₁/G₁, B₁/G₁), (R₂/G₂, B₂/G₂) for adjacent division areas on the color space is calculated based on the color information for each division area by the following expression.

D=√{(R₁/_{G}₁−R₂/G₂)²+(R₁/G₁−R₂/G₂)²} [Formula 2]

If the distance D calculated in this way is below a predetermined value, the color information in the division area is regarded as belonging to the same group, whereby the pieces of color information in 256 division areas are grouped. Instead of the above distance D, the value D² may be employed.

And when a predetermined number (e.g., five) or more of pieces of color information are included within each group, the group is regarded as the corn CORN used for the AWB adjustment, but the group including less than predetermined number or pieces of color information is not regarded as the corn CORN. In FIG. 5, two corns CORN1 and CORN2 are indicated.

For each corn CORNi (i=1, 2, . . . ) obtained in this way, R/G gain Gri and B/G gain Gbi for making the color information representing each corn CORNi (e.g., color information in the center of corn CORNi or average color information) the neutral gray (N gray) are obtained, and weighted by the number N of pieces within each corn CORNi to produce the R/G gain Gr and B/G gain Gb in accordance with the following expression for these RIG gain Gri and B/G gain Gbi (step S56).

Gr=ΣGri×Ni/ΣNi

Gb=ΣGbi×Ni/ΣNi [Formula 3]

The RGB gain values (WB correction values) for the RGB signals saved in the memory 18 are obtained from the R/G gain Gr and B/G gain Gb obtained in the above way (step S58). The RB gain values given to the RB signal are obtained by multiplying the required gain value given to the G signal by the R/G gain Gr and B/G gain Gb. When the required gain value given to the G signal is 1, the R/G gain Gr and B/G gain Gb are directly the RB gain values given to the RB signals.

The RGB signals saved in the memory 18 are corrected by the RGB gain values (WB correction values) calculated at step S58. Thereby, the white balance adjustment is made (step S60).

Thereafter, the RGB signals subjected to the white balance adjustment are processed through the gamma processing, YC processing, and recording processing in the same way as in the manual WB adjustment mode, and recorded in the recording medium 32 (steps S40 to S44).

At step S56, in the automatic WB adjustment mode, the R/G gain Gr and B/G gain Gb are calculated based on the RIG gain Gri and B/G gain Gbi to make the color information representing each corn CORNi the N gray, whereby the white balance adjustment is made to be photographed under the light source species of daylight (fair), irrespective of the light source species at the time of actual photographing.

Thus, it is preferable that the light source species at the actual photographing is discriminated based on the RGB signals stored in the memory 18, and the white balance adjustment is further made to produce the tint of the light source species according to the light source species at step S58.

The light source species at the time of photographing is automatically discriminated by obtaining the light source species having the color information to which the color information representing the corn CORN having the maximum number of pieces is closest among the color information of light source species such as fair, shade-cloudy, fluorescent lamp 1, fluorescent lamp 2, fluorescent lamp 3, and tungsten lamp, as shown in FIG. 3. Also, the light source species is automatically discriminated based on the number of pieces or the luminosity of the subject within the preset detection frame for each light source species on the R/G, B/G color space (refer to Japanese Patent Application Publication No. 2002-218495), and the discrimination method for the light source species is not limited to this embodiment.

The light source species may be discriminated before processing at step S56, the R/G gain Gri and B/G gain Gbi to make the color information representing each corn CORNi the color information corresponding to the light source species discriminated beforehand may be obtained at step S56, and the R/G gain Gr and B/G gain Gb may be calculated based on the R/G gain Gri and B/G gain Gbi.

Moreover, though in the automatic white balance adjustment method of this embodiment, the automatic white balance adjustment is made, employing all the corn CORNs in which the number of pieces of color information is greater than or equal to a predetermined number, the white balance correction value may be calculated, only employing the color information representing the corn CORN containing the maximum number of pieces, whereby the white balance adjustment for the RGB signals may be made based on the white balance correction values.

Also, the color information of division area is not limited to the color information on the RIG, B/G color space, but may be the color information on other color spaces.

What is claimed is:

1. An automatic white balance adjusting method, comprising:
a step of calculating the white balance correction values based on the RGB signals obtained from a color image pickup element; and
a step of adjusting the white balance of said RGB signals based on said calculated white balance correction values;
wherein said step of calculating the white balance correction values comprises:
a step of acquiring the color information for each of a plurality of division areas in which one screen is divided into a plurality of areas, based on said RGB signals within each division area;
a step of grouping the color information for said plurality of division areas for every color information similar to each other;
a step of counting the number of color information within each of the groups into which the color information is grouped and obtaining a specific group for use in calculating the white balance correction values based on said counted number; and
a step of calculating said white balance correction values based on the color information contained in said specific group.

2. The automatic white balance adjusting method according to claim 1, wherein said step of acquiring the color information of said division area comprises a step of integrating the RGB signals within said division area for each color to obtain an integrated value for each color, and a step of acquiring the ratios R/G and B/G of said integrated value for each color and having the ratios R/G and B/G as the color information of said division area.

3. The automatic white balance adjusting method according to claim 2, wherein said step of grouping comprises a step of acquiring the distance in the color information between said adjacent division areas on a color space represented by R/G and B/G, and a step of grouping the color information for said adjacent division areas as the same group when said acquired distance is less than or equal to a predetermined value.

4. The automatic white balance adjusting method according to claim 1, wherein said step of obtaining the specific group comprises obtaining the group, as said specific group, in which the number of color information within each of the groups into which the color information is grouped is greater than or equal to a predetermined number.

5. The automatic white balance adjusting method according to claim 4, wherein said step of calculating the white balance correction values comprises calculating the white balance correction values to make the representative color information representing the color information within each group the target color information, and calculating said white balance correction values by adding the calculated white balance correction values for each group that is weighted by the number of color information with each group, when there are a plurality of said specific groups.

6. The automatic white balance adjusting method according to claim 1, wherein said step of obtaining the specific group comprises obtaining, as said specific group, a group having the largest number of color information within each of the groups into which the color information is grouped.

7. The automatic white balance adjusting method according to claim 6, wherein said step of calculating the white balance correction value comprises calculating the white balance correction values to make the representative color information within said group having the largest number of color information the target color information.
